(19) United States
(12) Patent Application Publication
(10) Pub. No.: US 2006/0124702 A1
(43) Pub. Date: Jun. 15, 2006

(54) Method of soldering electronic part and soldering device for soldering the same

(75) Inventor: Jun Oonishi, Mizuho-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/272,666

(22) Filed: Nov. 15, 2005

(30) Foreign Application Priority Data
Dec. 14, 2004 (JP) 2004-361959

(51) Int. Cl. B23K 31/02

(52) U.S. Cl. 228/179.1; 228/56.5

(57) ABSTRACT

In a soldering method of soldering a lead of an electronic part to a land of a printed circuit board, a heating ray is applied in a condition that a shielding member is arranged on a surface of the printed circuit board around the land. The shielding member is disposed to prevent at least one of a direct ray and an indirect ray from applying to the printed circuit board around the land. Accordingly, the printed circuit board is prevented from burning around the land.

### CROSS REFERENCE TO RELATED APPLICATION

This application is based on Japanese Patent Application No. 2004-361959 filed on Dec. 14, 2004, the disclosure of which is incorporated herein by reference.

### FIELD OF THE INVENTION

The present invention relates to a method of soldering a lead of an electronic part to a land of a printed circuit board and a soldering device for soldering the same.

### BACKGROUND OF THE INVENTION

A method of soldering a lead of an electronic part to a land of a printed circuit board by radiating a heating ray from a light source such as a xenon lamp and a semiconductor laser is known. In this method, the lead is soldered by using non-contact light energy. However, a base of the printed circuit board is likely to be burned around the land.

In a soldering method disclosed in JP-A-6-132649, a laminated board that transmits light fairly well is used as a base of a printed circuit board. The laminated board forms through holes for passing through leads, and the periphery of each through hole is surrounded by a metallic-foil land. A front surface and a rear surface of the laminated board are covered with solder resist films. Further, the solder resist film is removed in a given area that extends substantially larger than an irradiation area of heating ray and also larger than a diameter of the metallic-foil land provided around the through hole, and the heating ray is applied thereon. Thus, the heating ray passes through the laminated board at the given area and reaches a side wall of the metallic-foil in the through hole and a wiring pattern on the rear surface. Accordingly, the soldering part is uniformly heated in short time.

Generally, the heating ray is highly reflected when the lead and the solder have high gloss on their surfaces. Further, the reflected ray may be applied to an area substantially wider than the area on which the heating ray is directly applied. That is, even in this method, the base of the printed circuit board may be burned by the reflected ray. Further, this method may not be effective to a base having low light transmission.

In a soldering method of JP-A-9-214122, a heating gas is applied to a lead located on an area where a laser beam is applied, thereby enhancing solder wettability at the lead. Even if the lead surface has a high gloss and an absorption rate of the heating ray is small, the lead is heated through hot air or hot inert gas. That is, it is not necessary to increase energy output of the heating ray and to extend an irradiation time. Accordingly, the lead is soldered to the printed circuit board without burning the base of the printed circuit board. However, an apparatus to apply the heating gas is additionally required.

### SUMMARY OF THE INVENTION

The present invention is made in view of the foregoing matter and it is an object of the present invention to provide a method of soldering an electronic part, and a device for soldering the same, which prevents a base of a printed circuit board from burning with a simple structure.

According to a method of soldering a lead of an electronic part to a land of a printed circuit board, a heating ray is applied in a condition that a shielding member is arranged on a surface of a printed circuit board around a land. The shielding member is disposed to prevent at least one of a direct ray and an indirect ray from applying to the surface of the printed circuit board around the land. Accordingly, it is less likely that a base of the printed circuit board is burned around the land.

Further, a soldering device of the present invention includes a light-emitting member and a shielding member. The light-emitting member applies a heating ray to a predetermined portion of a printed circuit board. The shielding member is arranged on a surface of the printed circuit board to prevent the light from directly or/and indirectly applying to the printed circuit board around the land. Accordingly, the burning of the base of the printed circuit board is reduced by the shielding member having a simple structure.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1A is a cross-sectional view of a soldering device and a soldering portion of a printed circuit board according to a first embodiment of the present invention;

FIG. 1B is a plan view of the soldering portion of the printed circuit board, viewed from the top, according to the first embodiment of the present invention;

FIG. 2A is a plan view of a printed circuit board and a shielding member according to a second embodiment of the present invention;

FIG. 2B is a cross-sectional view of a soldering portion taken along a line IIB-IIB of FIG. 2A;

FIG. 3A is a cross-sectional view of a soldering device and a soldering portion of a printed circuit board according to further another embodiment of the present invention; and

FIG. 3B is a plan view of the soldering portion shown in FIG. 3A, viewed from the top.

### DETAILED DESCRIPTION OF EMBODIMENTS

Embodiments of the present invention will be described hereinafter with reference to the drawings.

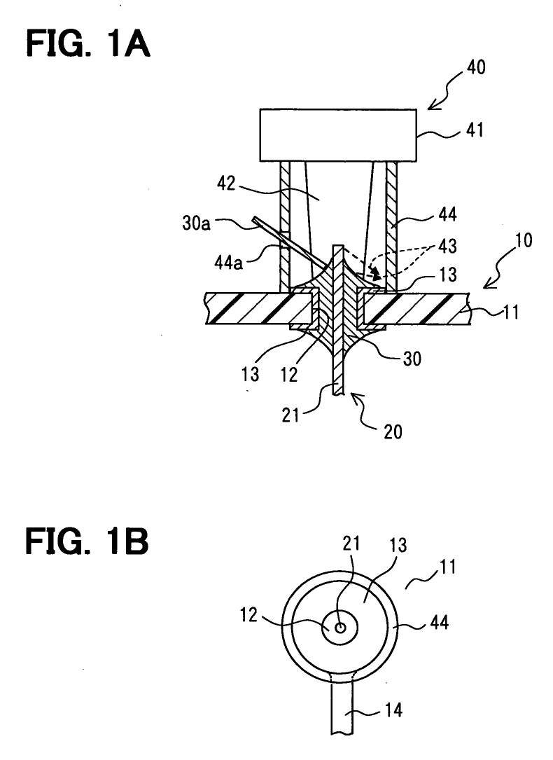

A soldering device of the first embodiment is shown in FIGS. 1A and 1B. In FIG. 1B, a laser emitter and a solder are not illustrated for convenience of the illustration. As shown in FIG. 1A, a printed circuit board 10 has lands 13 to which leads 21 of an electronic part 20 are soldered, on its surface as electrodes. Structures of the printed circuit board 10 other than the lands 13 are not particularly limited.

The printed circuit board 10 of the first embodiment has a base 11 and forms a through hole 12 penetrating the base 11 from a front surface to a rear surface. The base 11 is made of thermoplastic resin, such as liquid crystal polymer (LCP). A radial dimension of the through hole 12 is decided to a predetermined value in accordance with a diameter or a width of the lead 21 of the electronic part 20, so as to maintain solderbility and the quality of the soldered part.

Lands 13 are formed on the front and rear surfaces of the base 11 on perimeters of the through hole 12. In the embodiment, each of the lands 13 has a circular shape, for example. The lands 13 of the front and rear surfaces of the base 11 are electrically connected to each other through a conductive layer provided on an inner wall of the through hole 12, thereby forming an electrode. Further, the electrode is electrically connected to another part through a wiring pattern 14, as shown in FIG. 1B. Solder resists are formed on the front and rear surfaces of the printed circuit board 10 except at positions where the lands 13 are formed, although these are not illustrated in FIG. 1A for convenience.

The lead 21 extends from a package of the electronic part 20. The electronic part 20 includes a circuit element such as a condenser, a various type of semiconductor packages, and. a resistor. Here, the electronic part 20 is an insert-mounted type. That is, the electronic part 20 is mounted to the printed circuit board 10 by inserting and soldering the lead 21 in the through hole 12 of the printed circuit board 10. The lead 21 is made of a metallic material such as copper, and has a long, thin plate shape or a stick shape. Here, the electronic part 20 has any number of the leads 21.

A solder 30 is used as a connecting member. The solder 30 melts by receiving a heating ray and then becomes solid, thereby electrically connecting the lands 13 and the lead 21. Here, materials and form of the solder 30 are not limited. In the embodiment, a wire solder 30a is used, for example.

The soldering device 40 has a light emitting member for applying a heating ray to heat and melt the solder 30. For example, the light emitting member is a laser emitter 41 that radiates a laser beam having a predetermined wavelength. The heating ray radiated from the laser emitter 41 is not limited to a particular ray, as long as it can heat and melts the solder 30. For example, a semiconductor laser or a YAG laser can be applied as the laser beam 42. Further, the heating ray can be produced from a Xenon lamp.

In the first embodiment, a semiconductor laser having a wavelength between 800 nm and 1064 nm is used. The laser beam 42 is applied to a connecting portion between the lead 21 and the land 13, from the front side of the printed circuit board 10. Here, the laser beam 42 is concentrated by a condensing lens (not shown) so that the laser beam 42 is applied within a predetermined irradiation area (spot diameter).

The laser beam 42 from the laser emitter 41 is reflected by at least one of the lead 21 and the solder 30. Generally, the surface having a high gloss has a high reflectivity. Further, when output of the laser emitter is increased to shorten the time of soldering, the strength of the reflected ray increases. This may results in burning of the surface of the printed circuit board or the base.

To prevent such a burning, the soldering device 40 of the embodiment has a tube 44 as a shielding member (light-shielding means). Namely,the tube 44 prevents the laser beam 42 and a reflected ray 43 (shown by broken line in FIG. 1A), which is an indirect ray reflected by at least one of the lead 21 and the solder 30, from applying to the printed circuit board 10 around the land 13. The tube 44 is made of metal such as iron, aluminum, and copper, thereby absorbing the laser beam 42 and the reflected ray 43. Also, tube 44 can be made of alloy.

The tube 44 has a first open end and a second open end. The first open end is fixed to the laser emitter 41 such that an axis of the laser beam 42 is substantially coincident with an axis of the tube 44. As shown in FIGS.1A and 1B, the second end of the tube 44 has an inner shape corresponding to an outer shape of the land 13. Also, an inner dimension of the second end of the tube 44 is substantially the same as an outer dimension of the land 13 at least on the printed circuit board 10. In the embodiment, for example, the outer shape of the land 13 is substantially circle, so the tube 44 has a substantially circular shape in cross-section.

Further, the tube 44 forms at least one hole 44a on its wall for passing through the wire solder 30a. In the embodiment, the tube 44 forms one hole 44a. Depending on a location and a size of the hole 44a, the reflected ray 43 is likely to be emitted to the outside of the tube 44 through the hole 44a. Therefore, it is preferable to form the hole 44a at a location having little effect of the reflected ray 43. Alternatively, in a case that the hole 44a is formed at the location affected by the reflected ray 43, it is preferable to form the hole 44a with a minimum size to pass through the wire solder 30a.

Next, a method of soldering the electronic part 20 will be described with reference to FIG. 1A.

First, the printed circuit board 10 having the above-described structure and the electronic part 20 are prepared. The lead 21 is inserted into the through hole 12 of the printed circuit board 10 from the rear surface so that the end of the lead 21 projects from the front surface of the printed circuit board 10.

Then, the soldering device 40 is arranged on the front side of the printed circuit board 10 such that the second open end of the tube 44 is in contact with the base 11. In this condition, therefore, the end of the lead 21 and the land 13 on the front surface are enclosed in an inside space of the tube 44. Since the solder resists are provided on the both front and the rear surfaces of the printed circuit board 10, the second open end of the tube 44 substantially contacts the base 10 through the solder resist. Here, in a condition that the second open end of the tube 44 substantially contacts the base 11, the area underneath the tube 44 is also included as in the inside space of the tube 44.

Next, the laser beam 42 is applied toward the connecting portion between the land 13 and the lead 21 to heat up to a predetermined temperature that the solder 30 melts. For example, an irradiation area is adjusted so that the laser beam 42 is only applied to the inside space of the tube 44.

Next, while applying the laser beam 42, the wire solder 30a is fed through the hole 44a at a predetermined amount such that the wire solder 30a contacts at least one of the land 13 and the lead 21. Further, the laser beam 42 is applied for a predetermined time period, so a solder fillet is formed. During the radiation of the laser beam 42, the tube 44 shields or blocks the reflected ray 43, which is reflected by at least one of the solder 30 and the lead 21, so the reflected ray 43 is not radiated around the land 13 on the base 11. Accordingly, the land 13 and the lead 21 are mechanically fixed and electrically connected to each other through the solder 30.

In this way, the second open end of the tube 44 matches with the outer perimeter of the land 13 during the radiation of the laser beam 42. Therefore, the reflected ray 43 is blocked by the tube 44, and the base 11 is not affected by the indirect ray. Since the tube 44 is integrated with the laser transmitter 41 and the second end of the tube 44 is in contact with the base 11, a direct irradiation area, which directly receives the laser beam 42, is limited within the inside space of the tube 44. Accordingly, the base 11 is prevented from burning, with such a simple structure.

Since the tube 44 is fixed to the laser emitter 41, it is not necessary to adjust the axis of the laser beam 42 to the tube 44 for soldering every leads 21. That is, the number of steps during the soldering is reduced.

In the first embodiment, the wire solder 30a is used and the hole 44a is formed to feed the wire solder 30a. However, the shape of the solder 30 is not limited to the wire solder 30a. For example, another solder such as a paste solder can be used. In a case that the paste solder is used, it is previously applied to the connecting portion. Therefore, the hole 44a is not necessary.

It is preferable that the tube 44 is integrated into the laser emitter 41 since the axis of the laser beam 42 is not needed to adjust with respect to the tube 44 for every leads 21. However, the tube 44 can be provided separate from the laser emitter 41.

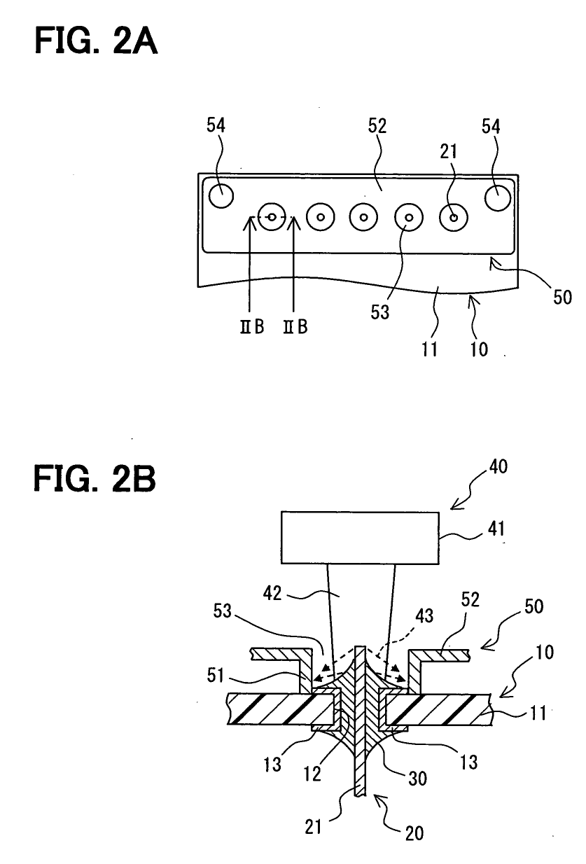

Next, a second embodiment of the present invention will be described with reference to FIGS. 2A and 2B. In FIG. 2A, the laser transmitter 41, the solder 30, and the lands 13 are not illustrated for convenience of the illustration. In the second embodiment, the structure of the shielding member is mainly different from that of the first embodiment. Namely, a shielding member 50 having a plurality of tubes 51 is used, in place of the shielding member of the first embodiment having the single tube 40. Specifically, the shielding member 50 is a single part and provided separate from the soldering device 40. Each of the tubes 51 correspond to each land 13.

The shielding member 50 is provided to prevent the laser beam 42 from directly and/or indirectly applied to the base 11 around the lands 13, similar to the first embodiment. Here, the indirect ray mainly means the reflected ray 43. Similar to the tube 44 of the first embodiment, the shielding member 50 is made of metal such as iron, aluminum, and copper, or alloy for absorbing the laser beam 42. The shielding member 50 includes the tubes 51 and a connecting plate portion 52 that connects the tubes 51. The connecting plate portion 52 has a plate shape. The end of each tube 51 has an inner shape corresponding to an outer shape of the land 13 and an inner dimension substantially the same as an outer dimension of the land 13. In this embodiment, the shielding member 50 has five tubes 51, for example.

The tubes 51 are integrated into the connecting portion 52 at positions corresponding to the lands 13. When the tubes 51 are fixed to the connecting plate portion 52 such as by welding, it is necessary to choose welding positions to the positions without receiving the laser beam 42 and the reflected ray 43. That is, it is preferable to weld the tubes 51 to the connecting portion 52 such that the welding portions are not affected by the laser beam 42 and the reflected ray 43.

In FIGS. 2A and 2B, numeral 53 represents an opening of the tube 51 on the plane surface of the connecting portion 52, and numeral 54 represents a positioning hole for positioning the shielding member 50 with respect to the printed circuit board 10. In the embodiment, at least two positioning holes 54 are formed on the connecting portion 52 to correspond to positioning holes or positioning parts (not shown) on the printed circuit board 10.

Next, a method of soldering the electronic part 20 of the second embodiment will be described with reference to FIG. 2B.

First, the lead 21 is inserted in the through hole 12 of the printed circuit board 10 from the rear side, so that the end of the lead 21 projects from the front side of the printed circuit board 10. Under this state, the shielding member 50 is placed on the front surface of the printed circuit board so that the positioning holes 54 of the shielding member 50 correspond to the positioning holes of the printed circuit board 10. Then, the shielding member 50 is fixed to the printed circuit board 10 by fixing members such as pins. Accordingly, the open end of each tube 51, which protrudes from the connecting portion 52, is connected to the base 11 around the land 13. Thus, the end of the lead 21 and the land 13 on the front surface of the printed circuit board 10 are contained in an inside space of the tube 51. Since the solder resists are provided on the front and rear surfaces of the printed circuit board 10 other than the lands 13, the open ends of the tubes 51 substantially contact the base 11 through the solder resists. Here, in a condition that the open end of the tubes 51 are connected to the front surface of the printed circuit board 10, the area underneath the tube 51 are also included as in the inside space of the tube 51, in addition to the end of the lead 21 and the lands 13.

Next, the irradiation area by the laser emitter 41 is adjusted. For example, the axis of the laser beam 42 is adjusted to the inside of the opening 53 of the tube 51 so that the laser beam 42 is applied to the inside of the tube 51. Then, the laser beam 42 is output from the laser emitter 41. Further, under a condition that the shielding member 50 is fixed to the printed circuit board 10, the wire solder is for example fed from a diagonally upper side of the opening 53 to solder the lead 21. The laser beam 42 is applied to the soldering portions through each tube 51 in due order. Thus, the connecting portions are sequentially soldered.

Accordingly, the electric part 20 is soldered to the printed circuit board 10 without burning the printed circuit board 10, by the soldering device 40 with the simple structure. Further, since the shielding member 50 has the plurality of tubes 51, the plurality of tubes 51 are positioned to the soldering parts at the same time. Accordingly, the plurality of leads 21 and the lands 13 are effectively soldered.

The present invention should not be limited to the above-disclosed embodiments, but may be implemented in other ways without departing from the spirit of the invention.

For example, the soldering method and the soldering device 40 of the embodiments can be also used to solder leads of a surface-mounted type electronic part such as QFP (Quad Flat Package) to lands of the printed circuit board.

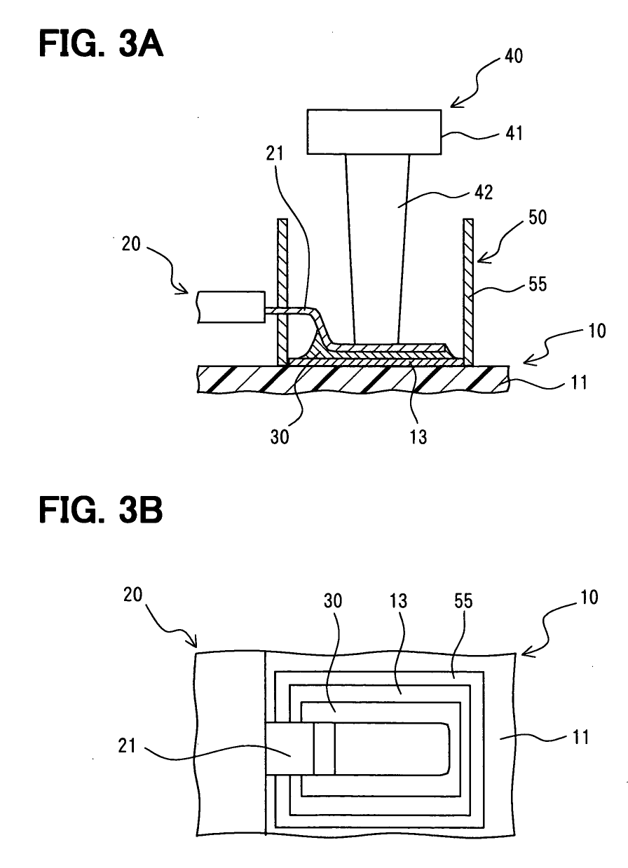

As shown in FIGS. 3A and 3B, a tube 55 is used as the shielding member 50. The tube 55 is made of metal such as iron, aluminum, and copper or alloy, for absorbing the laser beam 42 and the reflected ray 43. The tube 55 has an inner shape corresponding to an outer shape of the land 13 and an inner dimension substantially the same as an outer dimension of the land 13 at least on the front surface of the printed circuit board 11. Similar to the first and second embodiments, the tube 55 is arranged on the base 11 around the land 13. Also, the end of the tube 55 matches with the outer perimeter of the land 13. In this case, however, the tube 55 may interfere with the lead 21, depending on the height or length of the tube 55. Therefore, the tube 55 can be formed with slits extending from a necessary portion to the top of the tube 55 to pass through the lead 21. Here, a width of the slit is substantially same as the width of the lead 21.

In the above embodiments, the shielding members 44, 50, 55 are made of metal or alloy to absorb the laser beam 42 and the reflected ray 43, in order to reduce the burning of the base 11. However, the shielding member can be provided by other means, as long as it can prevent the direct ray and/or the indirect ray from applying around the lands 13.

For example, a reflecting member is arranged around the land 13 on the printed circuit board 10, as the shielding member. Thus, the shielding member of the present invention includes at least one of a member that can absorb the laser beam 42 and the reflected ray 43 and a member that reflects such rays, for reducing the burning of the base 11.

Further, since the shielding member including the tubes 44, 51, 55 and the connecting plate portion 52 are made of metal or alloy to absorb the laser beam 42 and the reflected ray 43, a low-heat conductive layer made of low-heat conductive material or a heat insulator can be provided on the printed circuit board 10. The low-heat conductive layer and the heat insulator are arranged in a predetermined area from the portion where the end of the tube 44, 51, 55 contacts the base 11 to a predetermined portion. In this case, heat transmission from the tubes 44, 51, 55 to the base 11 is reduced.

In the above embodiments, the solder 30 is used as the connecting member. However, another material that melts by heat and connects the lead 21 and the land 13 while hardening can be used as the connecting member.

Further, it is described that the inner dimension of the shielding member is substantially the same as the outer dimension of the land 13 on the surface of the printed circuit board 10. However, the inner dimension of the shielding member can be smaller than the outer dimension of the land 13 for reducing the burning of the base 11.

What is claimed is:

1. A method of soldering a lead of an electronic part to a land of a printed circuit board, comprising a step of applying a heating ray in a condition that a shielding member, which prevents at least one of a direct ray and an indirect ray from applying to a surface of the printed circuit board around the land, is arranged on the printed circuit board.

2. The method according to claim 1, wherein the indirect ray includes a reflected ray reflected by at least one of the lead and a solder.

3. The method according to claim 1, wherein
the printed circuit board forms a through hole and the land is provided around the through hole;
the shielding member has a tube, the tube has an open end having an inner shape corresponding to an outer shape of the land, an inner dimension of the open end of the tube is substantially the same as an outer dimension of the land; and
the heating ray is applied through the tube in a condition that the lead is located in the through hole and the open end of the tube is connected to the printed circuit board such that an end of the lead and the land are contained in an inside of the tube.

4. The method according to claim 3, wherein
the tube forms at least one hole on its wall; and
a solder is applied to a connecting portion between the lead and the land through the hole of the tube.

5. The method according to claim 3, wherein the shielding member has a plurality of tubes, and the heating ray is applied through the tubes in due order.

6. The method according to claim 1, wherein the heating ray is a laser beam.

7. A soldering device for soldering a land of an electronic part to a land of a printed circuit board, the soldering device comprising:
a light emitting member that radiates a heating ray; and
a shielding member that prevents at least one of a direct ray from the light emitting member and an indirect ray from applying to the printed circuit board around the land.

8. The soldering device according to claim 7, wherein the indirect ray includes a reflected ray reflected by at least one of the lead and a solder.

9. The soldering device according to claim 7, wherein the shielding member is integrated into the light emitting member.

10. The soldering device according to claim 7, wherein the shielding member has a tube having an open end, the open end has an inner shape corresponding to an outer shape of the land, and an inner dimension of the open end of the tube is substantially the same as an outer dimension of the land.

11. The soldering device according to claim 10, wherein the tube has at least one hole through which the solder is applied to a connecting portion between the lead and the land.

12. The soldering device according to claim 7, wherein the light emitting member radiates a laser beam as the heating ray.

13. The soldering device according to claim 9, wherein the shielding member has a tube having a first end and a second end, and the first end is fixed to the light emitting member so that an axis of the heating ray coincides with an axis of the tube.

14. The soldering device according to claim 10, wherein the shielding member has a plurality of tubes, and said tube is one of the plurality of tubes.
